(19) United States
(12) Patent Application Publication
(10) Pub. No.: US 2026/0326119 A1
(43) Pub. Date: Oct. 22, 2026

(54) GAS-LIQUID SEPARATOR FOR FUEL CELL VEHICLE

(71) Applicants: Hyundai Motor Company, Seoul (KR); Kia Corporation, Seoul (KR)

(72) Inventor: Min Jae KIM, Hwaseong-Si (KR)

(21) Appl. No.: 19/308,813

(22) Filed: Aug. 25, 2025

(30) Foreign Application Priority Data
Apr. 16, 2025 (KR) 10-2025-0049580

(51) Int. Cl. B04C 3/06; B01D 29/23; B01D 45/16; B01D 46/00; B01D 46/24; B01D 50/20; B04C 3/00; B04C 9/00; H01M 8/04119

(52) U.S. Cl. CPC B04C 3/06; B01D 29/23; B01D 45/16; B01D 46/0005; B01D 46/2403; B01D 50/20; B04C 9/00; H01M 8/04164; B01D 2201/0415; B01D 2265/06; B04C 2003/003; B04C 2003/006; B04C 2009/004; H01M 2250/20

(57) ABSTRACT

An apparatus for a fuel cell vehicle may comprise a casing part comprising a gas introduction opening, wherein the gas introduction opening is configured to generate swirls in a gas-liquid mixture such that the gas-liquid mixture, as introduced into the casing part, is subjected to a centrifugal force that causes gas and liquid in the gas-liquid mixture to be separated, and wherein the casing part is configured such that the separated gas flows through the casing part, a fluid guide disposed inside the casing part, wherein the fluid guide comprises an inner circumferential surface configured such that the separated gas and the separated liquid are rotated along the inner circumferential surface, a gas-liquid separator, and a filter part.

### CROSS-REFERENCE TO RELATED APPLICATION

This application claims the benefit of priority to Korean Patent Application No. 10-2025-0049580, filed in the Korean Intellectual Property Office on Apr. 16, 2025, the entire contents of which are incorporated herein by reference.

### TECHNICAL FIELD

The present disclosure relates to a gas-liquid separator for a fuel cell vehicle.

### BACKGROUND

The matters described in this Background section are only for enhancement of understanding of the background of the disclosure, and should not be taken as acknowledgment that they correspond to prior art already known to those skilled in the art.

A fuel cell electric vehicle (FCEV) generates electric energy through an electrochemical reaction of oxygen and hydrogen in a fuel cell stack and uses it as a power source.

Fuel cell vehicles may continuously generate electricity regardless of the capacity of the fuel cells by supplying fuel and air from the outside. Researches and developments are being carried out due to the advantages of high efficiency and little emission of contaminants.

Among fuel cells, a direct methanol fuel cell (DMFC) may be configured to directly supply methanol as fuel to positive electrodes of the cells and generate electricity through a reaction with oxygen supplied to negative electrodes. Electrons are generated in a positive electrode while a reaction, such as Chemical formula 1, occurs, and the electrons move to a negative electrode along a movement path to cause a reaction of Chemical formula 2.

CH₃OH+H₂O→CO₂+6H+6e⁻ [Chemical formula 1]

3/2 O₂+6H⁺+6e⁻→3H₂O [Chemical formula 2]

Furthermore, a method of supplying methanol to the positive electrode may include a method of supplying liquid methanol to a pump or guiding vaporized methanol to a positive electrode node by using the property of self-vaporization at room temperature.

As shown in Chemical formula 1, a mixture gas of carbon dioxide and unreacted methanol is generated in the positive electrode, and a mixture gas containing moisture is generated in the negative electrode.

In this way, the mixture gas introduced into the fuel cells may be humidified by a humidifier before being introduced into the fuel cell. However, when the mixture gas in an over-hygroscopic state is continuously supplied to the fuel cells, a flooding phenomenon may occur inside the fuel cells, resulting in deterioration of the performance and operation efficiency of the fuel cell stack.

The mixture gas generated at the positive electrode and the negative electrode may be separated into gas and liquid by using the gas-liquid separator, and the separated liquid may be discharged to the outside.

A gas-liquid separator may be clogged due to freezing when a size of a drain pipe, through which liquid is discharged, is small in a start stop/idle/low-speed driving environment in the winter season.

To the contrary, when a size of a drain pipe is set to be large in consideration of the freezing situation, a flow loss of the gas may increase and an amount of exhaust energy recovered by a turbine may decrease.

### SUMMARY

The present disclosure has been made to solve the above-mentioned problems occurring.

According to the present disclosure, an apparatus for a fuel cell vehicle, the apparatus may comprise a casing part may comprise a gas introduction opening, wherein the gas introduction opening is configured to generate swirls in a gas-liquid mixture such that the gas-liquid mixture, as introduced into the casing part, is subjected to a centrifugal force that causes gas and liquid in the gas-liquid mixture to be separated, and wherein the casing part is configured such that the separated gas flows through the casing part, a fluid guide disposed inside the casing part, wherein the fluid guide may comprise an inner circumferential surface configured such that the separated gas and the separated liquid from the gas-liquid mixture are rotated along the inner circumferential surface, and wherein the fluid guide is configured such that the separated liquid is dropped and discharged and the separated gas is concentrated at a central portion of the fluid guide due to a density difference between the separated gas and the separated liquid, a gas-liquid separator disposed in the fluid guide, wherein the gas-liquid separator is configured to separate remaining liquid contained in the separated gas, and a filter part configured to collect foreign substances from the separated liquid, which is discharged after passing through the fluid guide, block the separated gas, and collect foreign substances from the separated gas, which is discharged after passing through the gas-liquid separator.

The apparatus, wherein the casing part may comprise a first outer case part, in which the gas introduction opening is formed and in which a vane part is provided to generate the swirls in the gas-liquid mixture, and a second outer case part coupled to a rear side of the first outer case part, the second outer case part may comprise a gas discharge opening that extends in a direction facing the gas introduction opening and configured to discharge the separated gas, and a liquid discharge opening formed at a lower portion and configured to discharge the separated liquid.

The apparatus, wherein the vane part may comprise a first vane part installed at an inlet of the gas introduction opening, and a second vane part installed at the inlet of the gas introduction opening, wherein the inlet of the gas introduction opening is on one side of the first vane part.

The apparatus, wherein the first vane part is separately installed at the inlet of the gas introduction opening, and wherein the second vane part is formed integrally with the inlet of the gas introduction opening.

The apparatus, wherein the inlet of the gas introduction opening is formed in a cylindrical shape, wherein the cylindrical shape may comprise a first surface, on which the first vane part is installed, and a second surface, located on an inner side of the cylindrical shape, on which the second vane part is installed, and wherein the first vane part and the second vane part, each may comprise a wing portion and a fixing portion, and wherein the fixing portion is configured to fix an inner surface of the wing portion and an outer surface of the wing portion.

The apparatus, wherein the fixing portion of the second vane part may comprise an inner fixing portion configured to fix the inner surface of the wing portion, and an outer fixing portion configured as an inner surface of the inlet of the gas introduction opening.

The apparatus, wherein the fluid guide may comprise an outer circumferential surface portion having a smaller diameter than an outer circumferential surface portion of the second outer case part, such that the fluid guide is spaced apart from an inner circumferential surface portion of the second outer case part.

The apparatus, wherein the fluid guide may comprise a front opening portion having an open front surface, and a rear opening portion having an open rear surface, and wherein the rear opening portion may comprise a plurality of liquid discharge holes formed along an outer circumferential direction of a rear surface, and at least one gas discharge hole formed at a central portion of the rear surface.

The apparatus, wherein a front surface of the front opening portion is fully open, wherein a rear surface of the rear opening portion is partially open, and wherein the gas-liquid separator is disposed at a boundary between one of the plurality of liquid discharge holes and the at least one gas discharge hole.

The apparatus, wherein the fluid guide may comprise an eccentric circumferential surface portion having an arc shape of a radius, wherein a central axis of an inner circumferential surface of the eccentric circumferential surface portion is eccentric with respect to a central axis line of an outer circumferential surface of the eccentric circumferential surface portion, wherein the eccentric circumferential surface portion may comprise a stepped portion protruding from the inner circumferential surface toward a center of the fluid guide, and wherein a liquid exit hole, in communication with the liquid discharge opening, is formed in the fluid guide at a position adjacent to the stepped portion.

The apparatus, wherein the gas-liquid separator is connected to a gas discharge hole that is shared by the second outer case part and a rear surface of the fluid guide part, and wherein the gas-liquid separator may comprise a rear opening portion in communication with the gas discharge hole, and a front surface having a protruding cone portion, wherein the protruding cone portion protrudes forward such that an outer diameter of the protruding cone portion decreases toward a front side.

The apparatus, wherein the protruding cone portion is formed to protrude in a conic shape such that gas introduced through the gas introduction opening strikes the protruding cone portion and flows rearward along an inclined surface of the protruding cone portion, during which liquid is separated from the gas introduced through the gas introduction opening.

The apparatus, wherein a gas passage part is formed at a side portion of a circumferential surface of the gas-liquid separator and a lower surface portion of the circumferential surface of the gas-liquid separator, and wherein the gas passage part may comprise a gas passage hole, and a cover part configured to block the liquid from entering the gas passage hole and guide the liquid to the liquid discharge opening.

The apparatus, wherein the filter part may comprise a first filter part including a first filtration member having first holes, wherein the first holes are configured to collect foreign substances from the liquid, and a second filter part including a second filtration member having second holes, wherein the second holes are configured to collect foreign substances from the separated gas.

The apparatus, wherein the first filter part may comprise a filter case that holds the first filtration member and may comprise a through-hole for allowing liquid to pass through at least part of a surface of the filter case, and a filter tray that supports the filter case and the first filtration member.

The apparatus, wherein the filter tray may comprise an accommodation part that houses the filter case, and a drainage portion formed at a lower portion of the accommodation part and configured to discharge the liquid in a gravitational direction.

The apparatus, wherein the second filter part may comprise a filter frame that surrounds the second filtration member, and wherein the second filter part is housed in an interior of the gas-liquid separator.

The apparatus, wherein the filter frame may comprise a plurality of ribs, and wherein the plurality of ribs extend in a lengthwise direction and support the second filtration member.

According to the present disclosure, an apparatus may comprise a case may comprise a gas introduction opening and configured to generate a swirl in a gas-liquid mixture introduced through the gas introduction opening such that gas and liquid in the gas-liquid mixture are separated, a gas discharge opening configured to discharge the separated gas, a liquid discharge opening configured to discharge the separated liquid, and a gas-liquid separator may comprise a protrusion configured to deflect a flow of the separated gas rearward, a gas passage hole formed on a surface of the gas-liquid separator, and a cover part configured to guide the separated liquid to the liquid discharge opening.

According to the present disclosure, an apparatus for a fuel cell vehicle, the apparatus may comprise a first outer case may comprise a gas introduction opening and a first vane and a second vane configured to generate a swirl in a gas-liquid mixture introduced through the gas introduction opening such that gas and liquid in the gas-liquid mixture are separated, a second outer case coupled to the first outer case, the second outer case may comprise a gas discharge opening configured to discharge the separated gas and a liquid discharge opening configured to discharge the separated liquid, a fluid guide disposed within the second outer case, the fluid guide may comprise a front opening portion, a rear opening portion may comprise a plurality of liquid discharge holes disposed along a circumferential edge and at least one gas discharge hole disposed at a central portion, and an inner circumferential surface may comprise an eccentric arc-shaped portion and a stepped portion adjacent to a liquid exit hole aligned with the liquid discharge opening, a gas-liquid separator disposed at a central axis of the fluid guide and may comprise a cone-shaped protrusion configured to deflect gas flow rearward, a plurality of gas passage holes formed on side and lower surfaces of the gas-liquid separator, and a cover part configured to guide separated liquid to the liquid discharge opening, a first filter disposed at the liquid discharge opening and may comprise a drainage portion, and a second filter disposed within the gas-liquid separator and may comprise a filtration member having greater porosity than the first filter.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a fuel cell system of a fuel cell vehicle according to an example of the present disclosure;

FIG. 2 shows an example of a gas-liquid separator of a fuel cell vehicle according to an example of the present disclosure;

FIG. 3 shows an example of a gas-liquid separator of a fuel cell vehicle according to an example of the present disclosure;

FIG. 4 is an exemplary cross-sectional view showing a gas-liquid separator of a fuel cell vehicle according to an example of the present disclosure;

FIG. 5 shows an example of a first outer case part of a gas-liquid separator according to an example of the present disclosure;

FIG. 6 is an exemplary cross-sectional view showing a first outer case part of a gas-liquid separator according to an example of the present disclosure;

FIG. 7 is an exemplary cross-sectional view showing a front surface of a second outer case part of a gas-liquid separator according to an example of the present disclosure;

FIG. 8 is an exemplary cross-sectional view showing a side cross section of a second outer case part of a gas-liquid separator according to an example of the present disclosure;

FIG. 9 is an exemplary front view showing a fluid guide part of a gas-liquid separator according to an example of the present disclosure;

FIG. 10 is an exemplary cross-sectional view showing a fluid guide part of a gas-liquid separator according to an example of the present disclosure;

FIG. 11 shows an example of a flow state of a mixer of a gas-liquid separator of a fuel cell vehicle according to an example of the present disclosure;

FIG. 12 is an exemplary front view showing a front surface of a gas-liquid separating part of a gas-liquid separator according to an example of the present disclosure; and

FIG. 13 is an exemplary side view showing a side surface of a gas-liquid separating part of a gas-liquid separator according to an example of the present disclosure.

FIG. 14 shows an example computing system.

### DETAILED DESCRIPTION

Hereinafter, some examples of the present disclosure will be described in detail with reference to the accompanying drawings. In adding reference numerals to the components of the drawings, it should be noted that the same components have the same numerals as possible even when they are illustrated on different drawings. In describing examples of the present disclosure, detailed descriptions associated with well-known functions or configurations will be omitted if they may make subject matters of the present disclosure unnecessarily obscure.

Furthermore, in describing components of examples of the present disclosure, the terms first, second, A, B, (a), (b), and the like may be used herein. These terms are only used to distinguish one component from another component, but do not limit the corresponding components irrespective of the nature, order, or priority of the corresponding components. When it is described that a certain component is “connected to”, “coupled to” or “electrically connected to” a second component, it should be understood that the component may be directly connected or electrically connected to the second component, but a third component may be “connected”, “coupled” or “electrically connected” between the components.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Hereinafter, examples of the present disclosure will be described in detail with reference to accompanying drawings.

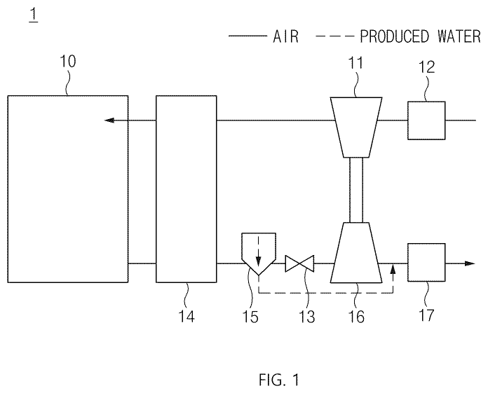

FIG. 1 shows an example of a fuel cell system of a fuel cell vehicle according to an example of the present disclosure.

Referring to FIG. 1, a fuel cell system 1 of a fuel cell vehicle according to the present disclosure includes a fuel cell battery 10 including a fuel electrode and an air electrode to generate electric energy through an electrochemical reaction of hydrogen and oxygen, a fuel supply device (not illustrated) that generates hydrogen from LNG that is a fuel and supplies it to the fuel electrode of the fuel cell battery 10, an air supply device (not illustrated) that supplies oxygen to the air electrode of the fuel cell battery 10, an electric energy output device (not illustrated) that supplies the electric energy generated by the fuel cell battery 10 to a load, and a controller (not illustrated) that properly controls the respective components (e.g., start-up logic, flow rates, output power, or shutdown protocols, etc.).

The air supply device includes a compressor 11 that compresses the air supplied to the fuel cell battery 10 to a pressure level sufficient for cell stack operation (e.g., above atmospheric pressure.

The compressor 11 may compress the air to supply the air in a compressed state so that the air supplied to the fuel cell battery 10 may have a pressure that is high enough such that the air passes through an internal flow path of the fuel cell battery 10. An inlet of the compressor 11 is provided with an air cleaner 12 for purifying the suctioned or intake air (e.g., removing dust, pollen, soot, or moisture, etc.).

A pressure control valve 13 may be a three-way valve that discharges the air discharged from a gas-liquid separator 15 that will be described later to a turbine 16. The pressure control valve 13 may control a rate and a direction of a flow of the air discharged from the gas-liquid separator 15. The pressure control valve 13 performs a function of a pressure regulator (e.g., regulating back pressure and selectively directing flow toward a bypass line, turbine, or muffler, etc.).

A humidifier 14 may be provided between the fuel cell battery 10 and the pressure control valve 13. The humidifier 14 serves to deliver moisture to the air introduced into the fuel cell battery 10 so that a separator of a membrane electrode assembly (MEA) of the fuel cell battery 10 is maintained at a specific humidity or more. The humidifier 14 humidifies the air supplied to the fuel cell battery 10 by utilizing generated water (e.g., recovered water from exhaust gas or product water from the electrochemical reaction via hollow fiber membranes, membrane exchangers, or heat-integrated evaporative chambers, etc.).

The gas-liquid separator 15 may be provided between the humidifier 14 and the pressure control valve 13. The gas-liquid separator 15 separates liquid (e.g., condensed water, entrained mist, or droplets carried from the humidifier or stack outlet, etc.) from the air supplied to the fuel cell battery 10 and discharges it to the outside.

The turbine 16 is a rotary mechanical device, and is rotated by the generated water (e.g., pressurized air stream or steam flow like high-pressure steam) discharged in a high-temperature and high-pressure gaseous state (e.g., during high-load fuel cell operation, regenerative braking air bursts, or purge cycles, etc.).

The turbine 16 may be connected to the compressor 11. Rotational power of the turbine 16 may assist a drive of the compressor 11 by applying power to the compressor 11 via a mechanical coupling (e.g., direct shaft, gear reduction system, or integrated electric generator, etc.).

Here, the fuel cell battery 10 may mean a fuel cell stack including a plurality of fuel cells (e.g., arranged in series or parallel, in planar, tubular, or serpentine configurations, etc.).

The fuel cell battery 10 generates electricity through an electrochemical reaction between the fuel and oxygen in the air. For example, hydrogen may be used as the fuel. When the fuel cell battery 10 is driven, electricity is generated through an electrochemical reaction between the fuel and oxygen, and water is generated as a reaction by-product. For example, the water generated by the fuel cell battery 10 is referred to as produced water or produced water of the fuel cell (e.g., discharged at the cathode, condensed in cooling channels, or trapped in GDLs, etc.).

The fuel cell may be formed in various structures that may generate electricity through redox reactions of the fuel (e.g., hydrogen) and an oxidizing agent (e.g., air) (e.g., in proton exchange membrane fuel cells (PEMFCs), solid oxide fuel cells (SOFCs), or alkaline fuel cells (AFCs), etc.).

For example, the fuel cell includes a membrane electrode assembly (MEA) (not illustrated), to which a catalytic electrode layer, in which an electrochemical reaction occurs, is attached on opposite sides of a membrane with respect to a separator, through which hydrogen ions flow, a gas diffusion layer (GDL) (not illustrated) that evenly distributes reactive gases and delivers the generated electrical energy, a gasket and a fastening mechanism (not illustrated) for maintaining airtightness and a proper fastening pressure of the reactive gases and cooling water, and a bipolar plate (not illustrated), through which the reactive gases and the cooling water flow (e.g., serpentine, interdigitated, or parallel channel types, etc.).

More specifically, in the fuel cell, hydrogen as that fuel and the air (oxygen) as an oxidizing agent are supplied to an anode and a cathode of the membrane electrode assembly through a flow passage of the bipolar plate, and hydrogen is supplied to the anode and air is supplied to the cathode (e.g., via humidified inlet channels, flow field plates, or back-pressure valves, etc.).

Hydrogen supplied to the anode is decomposed into protons and electrons by the catalyst of the electrode layers disposed on opposite sides of the separator. Among the protons and electrons, only protons selectively pass through the separator that is a cation exchange membrane to be delivered to the cathode, and at the same time, electrons are transferred to the cathode through the gas diffusion layer and the bipolar plate that are conductors (e.g., graphite-based, metallic, or composite bipolar plates, etc.).

In the cathode, protons supplied through the separator and electrons delivered through the bipolar plate meet oxygen in the air supplied to the cathode by the air supply device to generate a reaction of producing water. Due to the flow of protons, which occurs in this case, the flow of electrons through an external conductive wire occurs, and this flow of electrons generates current (e.g., to power traction motors, onboard electronics, or battery charging systems, etc.).

For the fuel cell battery 10 to be operated normally, it is necessary for the separator of the membrane electrode assembly to be maintained at a specific humidity or more. To this end, the air supplied to the fuel cell battery 10 along an air supply line (not illustrated) may pass via the humidifier 14, and may be humidified while passing through the humidifier 14. Here, humidification of the air may be defined as a process of increasing the humidity of the air (e.g., by water vapor diffusion, droplet injection, or enthalpy exchange, etc.).

As an example, the humidifier 14 may be configured to humidify the air (dry air) supplied to the fuel cell battery 10 by using the air (wet air) discharged from the fuel cell battery 10 (e.g., cathode exhaust, product gas, or moisture-laden purge gas, etc.).

The humidifier 14 may be provided in various structures that may humidify dry air by using the wet air discharged from the fuel cell battery 10, and the present disclosure is neither limited nor restricted by the structure of the humidifier 14 (e.g., parallel flow, cross-flow, or counter-flow humidifier layouts, etc.).

According to a preferred example of the present disclosure, the humidifier 14 may be provided between the compressor 11 and the fuel cell battery 10 (e.g., downstream of the air cleaner, upstream of the gas-liquid separator, or adjacent to the air intake manifold, etc.). Further, the humidifier 14 may be provided with an introduction gas supply port (not illustrated), through which the introduction gas (dry air) is introduced (supplied) into the humidifier 14. An introduction gas discharge port (not illustrated) may also be included, through which the humidified introduction gas is discharged after passing through an interior of the humidifier 14. Additionally, the humidifier 14 may also include a wet air supply port (not illustrated), through which the wet air discharged from the fuel cell 10 is supplied for humidification. A wet air discharge port (not illustrated) may also be provided to discharge the wet air that has been used to humidify the introduction gas (e.g., to an exhaust silencer, heat exchanger, or condensate separator, etc.).

The introduction gas supplied through the introduction gas supply port may be humidified by the wet air while passing through a humidifying membrane (e.g., a hollow fiber membrane) (not illustrated) provided in the interior of the humidifier 14. Then, the humidified introduction gas may be supplied to the fuel cell battery 10 through the introduction gas discharge port (e.g., via a humidified air manifold or distribution channel, etc.).

Furthermore, the wet air (or condensate) discharged from fuel cell battery 10 may be supplied to the wet air supply port to humidify the introduction gas in the interior of the humidifier 14 and then discharged to the outside through the wet air discharge port (e.g., connected to a downstream muffler, water trap, or drain reservoir, etc.).

Furthermore, the humidifier 14 may be connected to an exhaust line (not illustrated) that exhausts the air (air and condensate) and hydrogen (hydrogen and condensate) through the humidifier 14, and the exhaust line may be provided with an air pressure controller (APC) to form a back pressure in the interior of the fuel cell battery 10 and a silencer 17 for reducing exhaust noise of the exhaust gas (air and hydrogen) (e.g., caused by pulsed flow, gas-water mixing, or hydrogen bursts, etc.).

In this way, the exhaust gas of the fuel cell vehicle that generates electricity through a reaction of air, that is, oxygen and hydrogen, contains a large amount of humidified liquid to promote the reaction and produced liquid generated through a chemical reaction. When this exhaust gas is discharged directly through an exhaust duct, the performance of a muffler deteriorates, and thus, the gas-liquid separator 15 is used to separate the liquid in the exhaust gas (e.g., atomized droplets, condensate slugs, or moisture carried from the stack or humidifier, etc.).

The present disclosure proposes a gas-liquid separator 15 that may maximize an amount of retrieved energy by reducing flow loss of a liquid, satisfy a separation efficiency by effectively separating gas and liquid discharged at an outlet of the fuel cell battery 10, and prevent a passage clogging phenomenon due to freezing in the winter season (e.g., during cold start, idling, or low-speed driving, etc.) to be used in various environments.

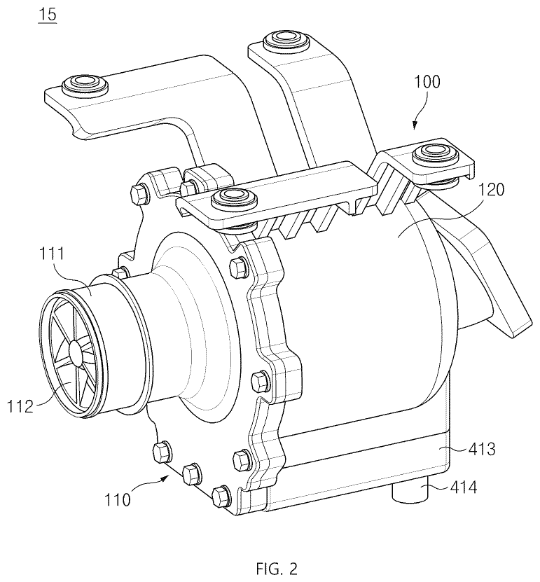

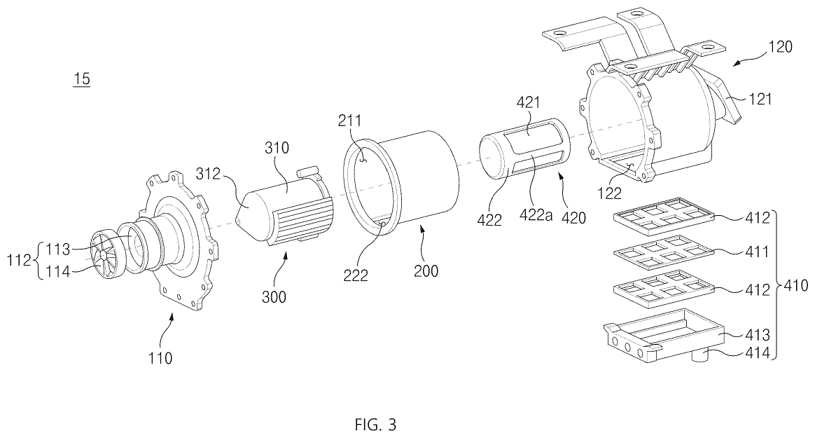

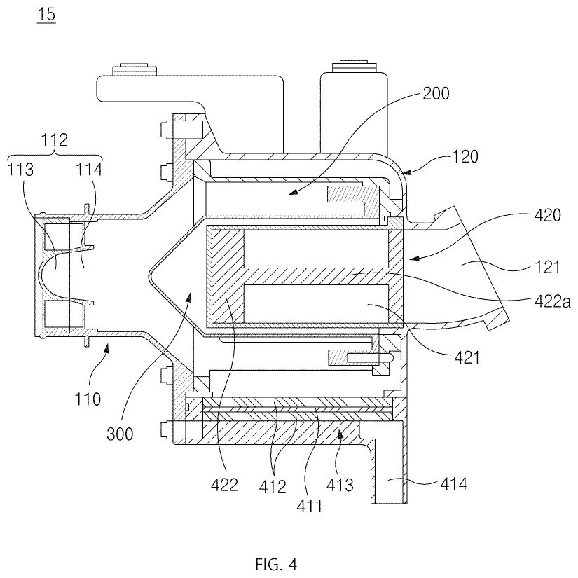

FIG. 2 shows an example of a gas-liquid separator 15 of a fuel cell vehicle according to an example of the present disclosure. FIG. 3 shows an example of a gas-liquid separator 15 of a fuel cell vehicle according to an example of the present disclosure. FIG. 4 is an exemplary cross-sectional view showing a gas-liquid separator 15 of a fuel cell vehicle according to an example of the present disclosure (e.g., showing the internal structure, flow paths, and filter positioning, etc.).

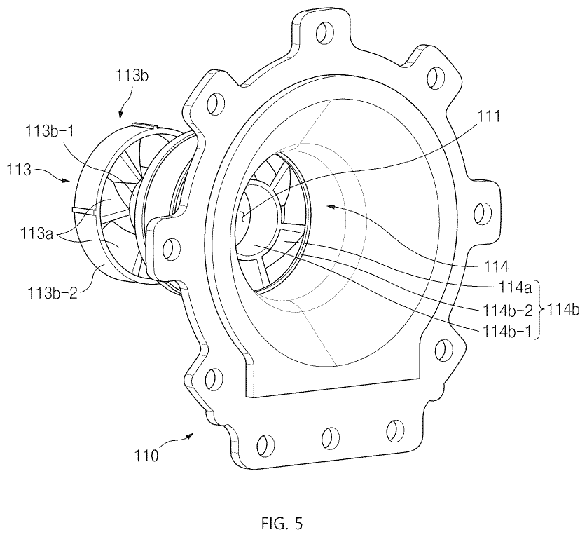

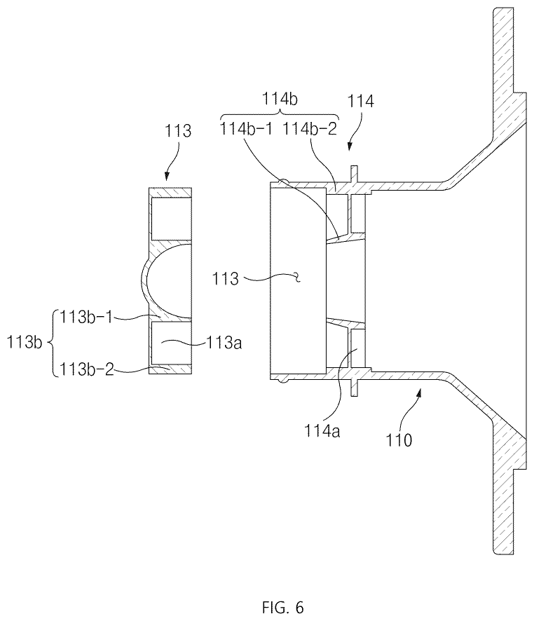

Furthermore, FIG. 5 shows an example of a first outer case part 110 of a gas-liquid separator 15 according to an example of the present disclosure, and FIG. 6 is an exemplary cross-sectional view showing a first outer case part 110 of a gas-liquid separator 15 (e.g., showing vane installation surfaces, internal wall contours, or inlet geometry, etc.) according to an example of the present disclosure.

Referring to the drawings, the gas-liquid separator 15 is configured to collect a small amount of liquid from the gas supplied to the fuel cell battery 10 (e.g., entrained mist, condensate, or aerosol droplets, etc.).

Referring to the drawings, the gas-liquid separator 15 of a fuel cell vehicle according to an example of the present disclosure includes a casing part 100, a fluid guide part 200, a gas-liquid separating part 300, and a filter part 400 (e.g., for staged separation, drainage control, and solid particle removal, etc.).

### Casing Part

The gas-liquid separator 15 may include a gas supply passage (not illustrated) for guiding gas (air) to the fuel cell battery 10. The casing part 100 of the gas-liquid separator 15 includes a first outer case part 110, in which a gas introduction opening 111 connected to a gas supply passage is formed (e.g., upstream of the vane, aligned with airflow direction, or coupled with an inlet duct, etc.).

In the first outer case part 110, a vane part 112 is formed in the gas introduction opening 111 so that swirls may occur from the gas that passes through the gas introduction opening 111 (e.g., to induce centrifugal motion, promote droplet separation, or stabilize the flow path, etc.).

The vane part 112 is configured so that the gas that passes through the gas introduction opening 111 may exert a centrifugal force due to the swirls.

Here, a swirl phenomenon of the gas that passes through the gas introduction opening 111 may be defined as a flow of a vortex type gas that occurs when the gas flows along the gas introduction opening 111 (e.g., spiral motion around the central axis, radial velocity gradient, or angular momentum induction, etc.).

In this gas swirl phenomenon, when the gas that flows through the gas supply passage flows into the gas introduction opening 111, the swirls occur due to the vane part 112 provided in the interior of the gas introduction opening 111, and the gas that contains liquid may be pushed in an outward direction with respect to a central axis of the gas introduction opening 111 by the specific gravity difference (e.g., separating denser water droplets from lighter gas molecules, etc.).

The gas introduced into the gas introduction opening 111 may generate a swirl by the vane part 112, and the liquid may be separated from the gas by a density difference. For example, the separated gas may be concentrated at a central portion of the gas-liquid separator 15 (e.g., for discharge through a central outlet tube or inner guide channel, etc.).

As illustrated in FIGS. 5 and 6, the vane part 112 includes a first vane part 113 that is installed separately at the inlet of the gas introduction opening 111 of the gas-liquid separator 15, and a second vane part 114 that is installed integrally with the inlet on one side of the first vane part 113 (e.g., molded into the housing or fixed to a collar ring, etc.).

The inlet of the gas introduction opening 111 may be formed in a cylindrical shape having a first surface, on which the first vane part 113 is installed, and a second surface, on which the second vane part 114 is installed, on an inner side thereof. For example, a side, on which the first surface is formed, may be defined as a front side, and a side, on which the second surface is formed, may be defined as a rear side (e.g., corresponding to the airflow direction from inlet to outlet, etc.).

The first vane part 113 is installed on a first surface on a front side of the inlet of the gas introduction opening 111, and includes a wing portion 113a and a fixing portion 113b (e.g., attached via press-fitting, fasteners, or insert molding, etc.).

A plurality of wing portions 113a are provided in the first vane part 113 to be spaced apart from a central part thereof by a specific distance and extend in an outward direction to form a flow of the gas (air) (e.g., in a spiral, helical, or angled configuration, etc.).

The fixing portion 113b includes an inner fixing portion 113b-1 that is formed in a cylindrical shape and fixes the inner surface of the wing portion 113a, and an outer fixing portion 113b-2 that fixes an outer surface of the wing portion 113a (e.g., to stabilize swirl generation and prevent deformation under airflow, etc.).

Furthermore, the second vane part 114 is installed on a second surface (on a rear side of the first vane part 113) on a rear side of the inlet of the gas introduction opening 111, and includes a wing portion 114a and a fixing portion 114b (e.g., formed as an integrated ring or molded frame, etc.).

A plurality of wing portions 113a are spaced apart from a central part thereof by a specific distance and extend in an outward direction to form a flow of the gas (e.g., in coordination with the first vane part to enhance swirl intensity and separation efficiency, etc.). The second vane part 114 includes an inner fixing portion 114b-1 that fixes an inner surface of the wing portion 114a, and an outer fixing portion 114b-2 that fixes an outer surface of the wing portion 114a. Here, the outer fixing portion 114b-2 may be defined as an inner surface of the inlet of the gas introduction opening 111 (e.g., formed as a radial support rib, embedded groove, or molded bracket, etc.).

The above-configured vane part 112 may generate swirls when the gas passes therethrough, and may separate the liquid from the gas due to the swirls (e.g., by centrifugal force acting on heavier liquid droplets, etc.). The gas and the liquid may be introduced into the gas-liquid separator 15.

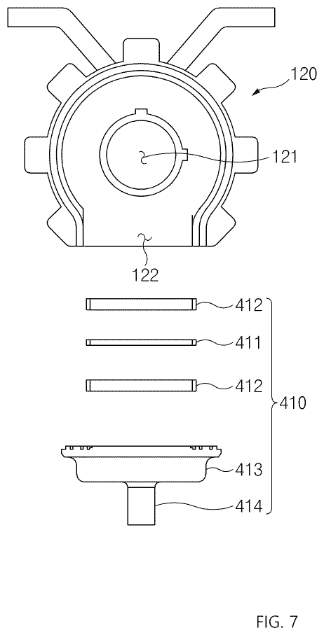

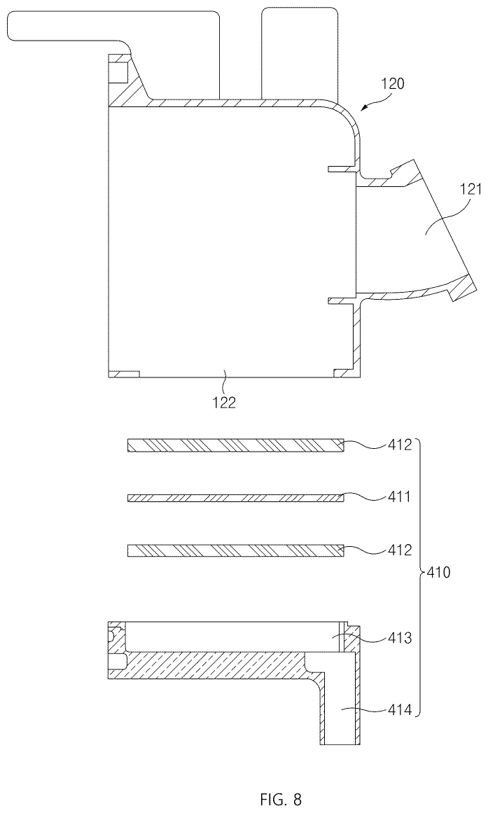

FIG. 7 is an exemplary cross-sectional view showing a front surface of a second outer case part 120 of the gas-liquid separator 15 according to an example of the present disclosure. FIG. 8 is an exemplary cross-sectional view showing a side cross section of the second outer case part 120 of the gas-liquid separator 15 (e.g., showing inner cavity geometry, port alignment, or sealing features, etc.) according to an example of the present disclosure.

Referring to the drawings, the second outer case part 120 may be coupled to a rear side of the first outer case part 110. For example, the first outer case part 110 and the second outer case part 120 may generally be coupled to each other by screw-coupling (e.g., via threaded collars, snap-fit interfaces, or bolted flanges, etc.).

A flow space, in which the gas and the liquid flow, is formed in an interior of the second outer case part 120 (e.g., shaped as a cylindrical chamber, a tapered channel, or a vortex cavity, etc.). A gas discharge opening 121 of the second outer case part 120 is formed in the flow space to extend in a direction that faces the gas introduction opening 111 of the first outer case part 110 (e.g., to support a straight-through or coaxial flow path design, etc.).

A liquid discharge opening 122, through which the liquid separated from the gas is formed at a lower portion of the second outer case part 120 (e.g., for gravitational drainage or freeze-prevention flow guidance, etc.).

A first filter part 410 that physically filters out foreign substances from the discharged liquid is installed in the liquid discharge opening 122 (e.g., to capture particulates, prevent downstream clogging, or protect sensors, etc.).

### First Filter Part

The first filter part 410 includes a first filtration member 411, in which fine holes are formed, a filter case 412, in which the first filtration member 411 is interposed, and in which a through-hole 412a, through which the liquid passes, is formed over an entire surface or a partial surface thereof, and a filter tray 413, in which the filter case 412 including the first filtration member 411 is seated (e.g., to allow modular replacement, secure fitment, or drainage alignment, etc.).

Here, the first filtration member 411 may be formed of a fiber sheet that is formed by regularly or irregularly laminating fine chemical fibers with a diameter of several micrometers to several tens of micrometers, non-woven fabric that is formed by bonding laminated chemical fibers with adhesive or through fusion, an aggregate of ceramic fine particles, a mesh-type stainless steel screen, or a porous sheet of a synthetic resin material, and the like. Furthermore, the first filtration member 411 is densely formed enough to reliably collect fine foreign substances by forming the fine holes with a small porosity (e.g., depending on liquid viscosity and particle size, etc.).

An accommodation part, in which the filter case 412 is accommodated, is formed in the filter tray 413, and a drainage portion 414, through which the liquid may be discharged in the gravitational direction, is formed at a lower portion of the accommodation part (e.g., aligned with vehicle tilt angle or mounted to avoid backflow, etc.).

The drainage portion 414 is a pipe-shaped member, through which the liquid is discharged, and a diameter of the pipe may be set such that the liquid discharged to the outside is not frozen (e.g., by maintaining a minimum flow rate, using heat-insulating material, or applying electric heating, etc.). The diameter of the pipe may be set to 20 mm or more. However, when the diameter of the pipe may be set to 20 mm or less as long as the liquid is not frozen therein (e.g., depending on insulation, heating, or regional climate considerations, etc.).

Accordingly, the liquid discharged through the liquid discharge opening 122 may be discharged to the outside through the drainage portion 414 after foreign substances are physically filtered out by the first filter part 410 (e.g., such as dust, rust flakes, or condensate-borne particulates, etc.). In particular, by setting the diameter of the pipe of the drainage portion 414 to as large as 20 mm or more, it is possible to prevent a clogging phenomenon of the pipe due to freezing in the winter season (e.g., caused by residual water, low ambient temperature, or restricted flow, etc.).

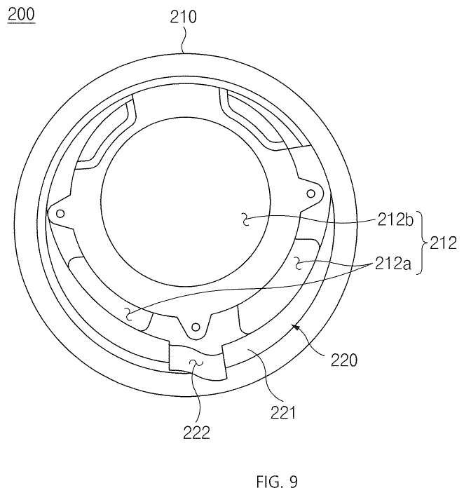

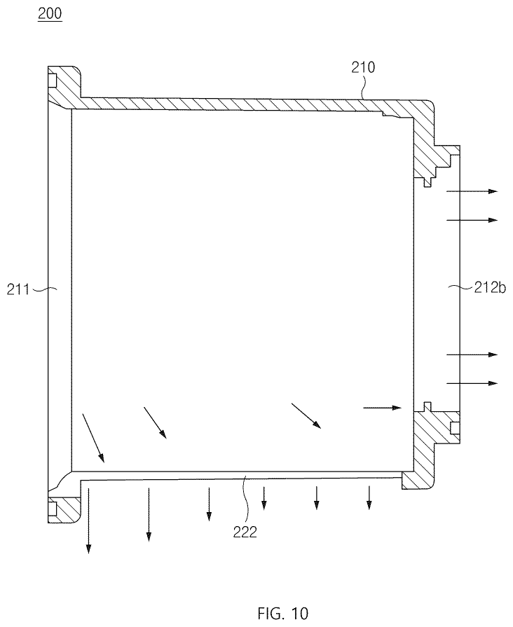

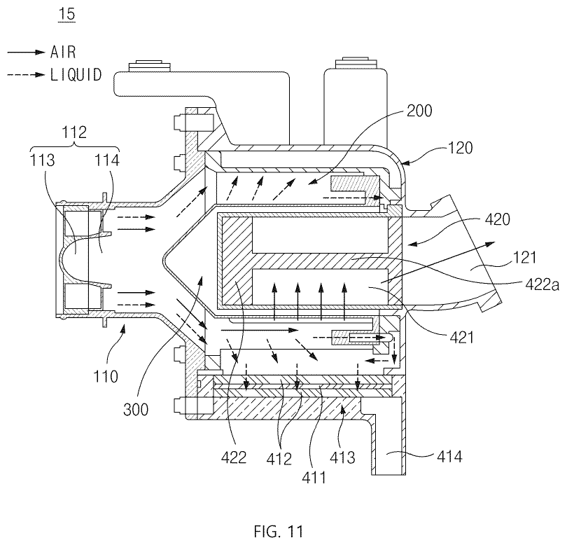

FIG. 9 is an exemplary front view showing the fluid guide part 200 of the gas-liquid separator 15 according to an example of the present disclosure, FIG. 10 is an exemplary cross-sectional view showing the fluid guide part 200 of the gas-liquid separator 15 according to an example of the present disclosure, and FIG. 11 shows an example of a flow state of the gas-liquid separator of the fuel cell vehicle according to an example of the present disclosure (e.g., depicting swirl formation, separation zones, or discharge pathways, etc.).

### Fluid Guide Part

Referring to the drawings, the fluid guide part 200 may be accommodated in the second outer case part 120. The outer circumferential surface portion of the fluid guide part 200 has a diameter that is smaller than that of the inner circumferential surface portion of the second outer case part 120 (e.g., creating an annular gap for liquid drainage, vortex stabilization, or airflow balancing, etc.), and thus, is spaced apart from the inner surface of the second outer case part 120 by a specific interval (e.g., to form a clearance for liquid flow, pressure equalization, or drainage bypass, etc.).

The fluid guide part 200 may be moved toward a rear side of the gas-liquid separator 15 while being rotated along a peripheral portion of an outer side with respect to a central portion of the fluid guide part 200 in a state, in which the liquid contained in the gas is separated from the gas by a centrifugal force due to swirls (e.g., generated by vanes, curved channels, or tangential inlets, etc.).

The fluid guide part 200 includes a housing 210 including a front opening portion 211 that is fully opened on a front surface thereof, and a rear opening portion 212 that is partially opened on a rear surface thereof (e.g., to direct separated gas and liquid to respective downstream components, etc.).

A liquid discharge hole 212a and a gas discharge hole 212b may be partially formed at the rear opening portion 212 (e.g., along different radial zones or flow paths, etc.).

A plurality of liquid discharge holes 212a may be formed along the outer circumferential direction of the rear opening portion 212, and at least one gas discharge hole 212b may be formed at a central portion of the rear surface (e.g., to allow separated liquid to exit peripherally while dried gas exits centrally, etc.).

A gas-liquid separating part 300 that will be described later may be disposed at a boundary of the liquid discharge hole 212a and the gas discharge hole 212b (e.g., to promote directional separation and minimize re-entrainment of liquid droplets, etc.).

A plurality of fastening holes (not illustrated) may be formed on a rear surface of the fluid guide part 200 such that the fluid guide part 200 is fixed to the second outer case part 120 by fastening a fastening member (not illustrated) (e.g., screws, bolts, or locking tabs, etc.).

As illustrated in FIG. 9, according to an example of the present disclosure, an eccentric circumferential surface portion 220, in which a central axis of an inner circumferential surface is eccentric with respect to a central axis line of the outer circumferential surface, may be included on an inner circumferential surface of the fluid guide part 200 (e.g., to induce asymmetric swirling, control drainage path, or suppress turbulence, etc.).

An eccentric arc of a large radius “R” may be formed at the eccentric circumferential surface portion 220 (e.g., greater than the nominal circular radius of the inner surface, etc.).

The eccentric circumferential surface portion 220 may be formed as one ellipse together with an inner circumferential surface of the fluid guide part 200 by forming an eccentric arc along the inner circumferential surface (e.g., through off-axis molding or multi-radius shaping, etc.).

The arc of the large radius “R” with respect to a central axis of the inner circumferential surface of the fluid guide part 200 may be formed at a portion of an inner circumferential surface of the eccentric circumferential surface portion 220 (e.g., offset to increase liquid collection efficiency along the lower region, etc.).

In this way, when the eccentric circumferential surface portion 220 is formed as an ellipse with a large radius “R” on the inner circumferential surface of the fluid guide part 200, the eccentric circumferential surface portion 220 has a radius “R” different from that of the inner circumferential surface (e.g., offset by design to induce asymmetric flow, enhance separation, or guide liquid migration, etc.) of the fluid guide part 200. Accordingly, as the eccentric circumferential surface portion 220 protrudes from an inner circumferential surface of the fluid guide part 200 toward a center thereof, a stepped portion 221 is formed on one side of the inner circumferential surface of the fluid guide part 200 (e.g., forming a liquid-guiding ramp or pocket, etc.).

The stepped portion 221 serves to guide the liquid that is introduced into the fluid guide part 200 and rotated by swirling flow, to the liquid discharge opening 122 of the second outer case part 120, while the liquid travels along the stepped portion 221 (e.g., under centrifugal force, gravitational pull, or angular momentum, etc.). A liquid exit hole 222, which is communicated with the liquid discharge opening 122, is formed at a lower end of the fluid guide part 200 at a position adjacent to the stepped portion 221 (e.g., to allow efficient drainage, reduce pooling, or prevent backflow, etc.). Accordingly, the liquid guided to the liquid exit hole 222 by the stepped portion 221 may be discharged to the liquid discharge opening 122 of the second outer case part 120 (e.g., minimizing residual pooling or freeze risk, etc.).

Referring to FIG. 11, the remaining liquid, whose flow force becomes weaker as it flows rearward and which fails to be discharged to the liquid discharge opening 122, in the liquid that flows in the fluid guide part 200, may be discharged through the liquid discharge hole 212a of the rear opening portion 212, which is located on a rear side (e.g., due to low momentum, wall adhesion, or uneven centrifugal separation, etc.). The remaining liquid discharged through the plurality of liquid discharge holes 212a may flow downward while colliding with a rear surface of the second outer case part 120 and may be continuously discharged to the liquid exit hole 222 and the liquid discharge opening 122 (e.g., by gravitational force, centrifugal effect, or guided drainage design, etc.).

The gas, whose flow rate is high, and that flows in the fluid guide part 200 flows to the first filter part 410 located at a lower end of the fluid guide part 200, but a choked flow phenomenon occurs due to the fine holes of the first filtration member 411 (e.g., when gas velocity approaches sonic speed or when pressure differential exceeds critical limits, etc.). Accordingly, the gas of the high flow rate fails to pass through the first filtration member 411 to be discharged, and flows to the gas-liquid separating part 300. Here, the choked flow phenomenon refers to a phenomenon in which a flow rate of the gas of a compressive flow is limited (e.g., when pressure differential reaches a critical threshold, or when outlet velocity approaches sonic speed, etc.).

In this way, when the gas with a high flow rate cannot pass due to a flow resistance of the first filtration member 411, a flow loss of the gas is reduced or minimized, and thus, an exhaust energy recovery efficiency of the turbine 16 may be improved (e.g., by maintaining higher back pressure, stabilizing flow velocity, or preventing turbulence, etc.).

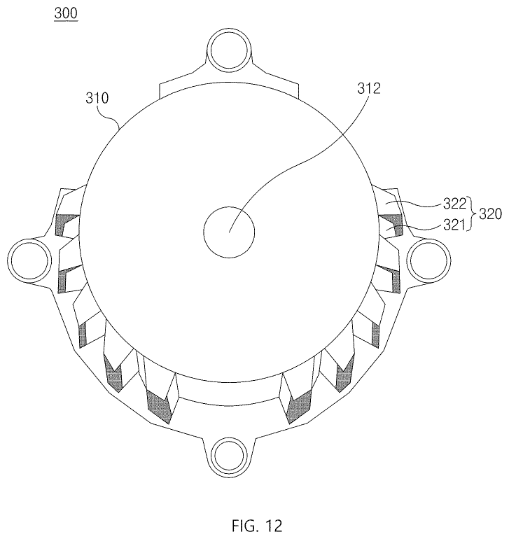

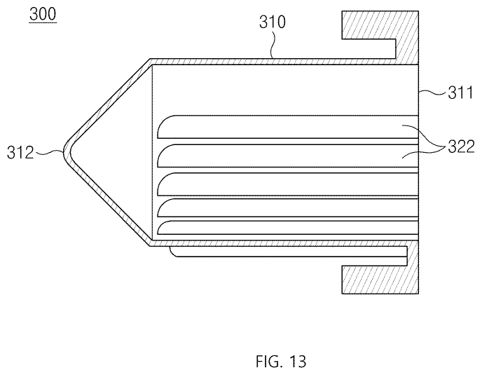

FIG. 12 is an exemplary front view showing a front surface of the gas-liquid separating part 300 of the gas-liquid separator 15 according to an example of the present disclosure. FIG. 13 is an exemplary side view showing a side surface of the gas-liquid separating part 300 of the gas-liquid separator 15 according to an example of the present disclosure.

### Gas-Liquid Separating Part

Referring to the drawings, the gas-liquid separating part 300 may be disposed on the central axis line of the fluid guide part 200, and may be connected to the gas discharge opening 121 shared by the second outer case part 120 and a rear surface of the fluid guide part 200 (e.g., to ensure coaxial alignment, reduce flow resistance, or streamline exhaust routing, etc.). The gas-liquid separating part 300 may separate the liquid from the gas, and only the separated gas may be discharged to the outside through the gas discharge opening 121 (e.g., preventing mist carryover, protecting downstream turbine blades, or improving purity of exhaust flow, etc.).

The gas-liquid separating part 300 includes a hollow cylinder-shaped housing 310 including a rear opening portion 311 that is communicated with the gas discharge opening 121 that is fully opened on a rear surface thereof, and a protruding cone portion 312 that is formed to protrude such that an outer diameter thereof becomes smaller toward a front side, on a rear surface thereof (e.g., to streamline flow, induce vortex shedding, or enhance separation inertia, etc.).

As described above, the rear opening portion 311 may be coupled to the gas discharge opening 121 to be communicated therewith (e.g., via tight-fitting, sealing, or screw engagement, etc.).

The protruding cone portion 312 may be formed to protrude in a cone shape such that the gas containing the liquid introduced through the gas introduction opening 111 collides therewith and flows rearward along an inclined surface in a state, in which the liquid is separated from the gas (e.g., via inertia, centrifugal motion, or wall impact, etc.).

In the example of the present disclosure, the protruding cone portion 312 is formed in a cone shape, but the present disclosure is not limited thereto, and may be formed in a polygonal cone shape having a plurality of corners (e.g., triangular, square-based, or hexagonal, etc.).

A gas passage part 320 is formed at side portions and a lower portion, except for an upper portion, of a circumferential surface of the housing 310.

The gas passage part 320 may include a gas passage hole 321, and a cover part 322, through which the gas passes while blocking the liquid, and that guides the gas to the liquid discharge opening 122. The cover part 322 is formed in a curved shape such that the liquid slides and drops due to the gravity. However, the present disclosure is not limited thereto, and an inclined portion that is inclined downward may be employed (e.g., using ramped surfaces, sloped baffles, or contoured channels, etc.).

The reason why the gas passage part 320 is not formed on an upper surface of the housing 310 of the gas-liquid separating part 300 is that the liquid that flows to an upper side of the housing 310 of the gas-liquid separating part 300 is allowed to flow downward by the gravity while being rotated along a peripheral portion of an outer side of the fluid guide part 200 (e.g., following centrifugal paths, reducing splash-back, or promoting efficient drainage, etc.). Furthermore, the cove part 322 is to prevent the liquid from being introduced into the gas passage hole 321 while flowing downward. The liquid that has dropped may be discharged to the liquid discharge opening 122 by the gravity while failing to be introduced to a side surface and a lower surface of the housing 310 (e.g., ensuring liquid bypasses gas outlets, minimizing mist carryover, or stabilizing drain paths, etc.).

A second filter part 420 is inserted into and installed within an interior of the gas-liquid separating part 300.

### Second Filter Part

The second filter part 420 is in fluid communication with the gas discharge opening 121 while being accommodated in an interior of the gas-liquid separating part 300.

The second filter part 420 includes a second filtration member 421, in which fine holes are formed, and a cylindrical filter frame 422 that surrounds the second filtration member 421 (e.g., to provide mechanical support, resist deformation, or guide airflow, etc.).

The second filtration member 421 has a thin plate shape and is formed by rolling the plate into a cylindrical configuration.

The second filtration member 421 may be the same as the above-described first filtration member 411 in examples of material, properties, and functions (e.g., fiber composition, liquid repellency, or durability, etc.). However, the fine holes of the second filtration member 421 may be formed such that the porosity thereof is greater than that of the fine holes of the first filtration member 411 (e.g., to reduce flow resistance, accommodate higher gas velocity, or reduce pressure drop, etc.). This is to prevent the gas that flows to the second filtration member 421 from being blocked by the first filter part 410 due a choked flow phenomenon (e.g., flow saturation, pressure drop, or backpressure buildup, etc.).

The filter frame 422 is a structural component that maintains a cylindrical shape of the second filtration member 421 by inserting the second filtration member 421 thereinto, and A plurality of ribs 422a may be formed in the filter frame 422 to support the second filtration member 421 (e.g., by preventing collapse, resisting vibration, or maintaining airflow channels, etc.). The ribs 422a may support the second filtration member 421 in a lengthwise direction (e.g., to prevent collapse, ensure uniform spacing, or stabilize flow patterns, etc.).

Accordingly, when the gas introduced through the gas passage part 320 of the gas-liquid separating part 300, and the liquid comes into contact with the second filtration member 421 of the second filter part 420, the gas may flow to an inside of the second filter part 420 while passing through the second filtration member 421. Furthermore, the foreign substances contained in the gas may be collected in the fine holes of the second filtration member 421 (e.g., particulates, condensate aerosols, or carbon dust, etc.).

The liquid that swirls around a circumference of the gas-liquid separating part 300 descends to the first filter part 410 due to the gravity, and after the foreign substances are physically filtered out by the first filtration member 411 of the first filter part 410 (e.g., dust, debris, or condensed oil mist, etc.), the liquid may be discharged to the outside through the drainage portion 414.

The gas that flows to an inside of the second filter part 420 may be discharged to the outside through the gas discharge opening 121 of the second outer case part 120, which is connected to the second filter part 420 (e.g., via an exhaust line, recovery turbine, or silencer, etc.).

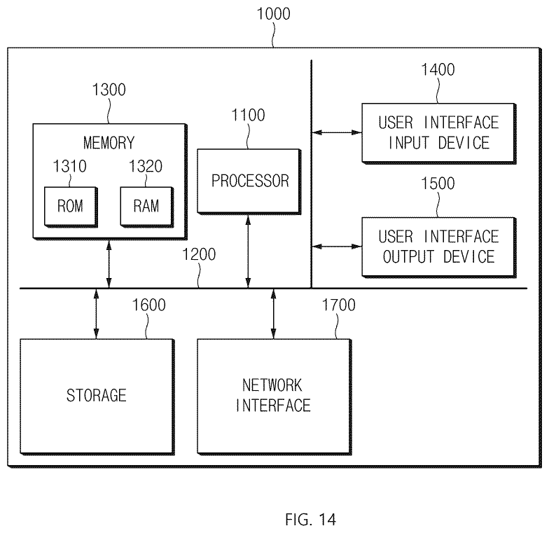

FIG. 14 shows an example computing system (e.g., a controller of a fuel cell system or any other apparatus). One or more controllers, processors, etc. described herein, such as one or more components of a fuel cell system, one or more components of a fuel cell vehicle, and any other components and devices disclosed herein, may be implemented by or in the computing system as shown in FIG. 14.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

An example of the present disclosure provides a gas-liquid separator for a fuel cell vehicle that may maximize an amount of retrieved energy by reducing flow loss of gas, satisfy a separation efficiency by effectively separating gas and liquid discharged at an outlet of the fuel cell battery, and prevent a passage clogging phenomenon due to freezing in the winter season to be used in various environments.

Objects of the present disclosure are not limited to the above-mentioned object, and other objects and advantages of the present disclosure that is not mentioned will be understood from the following description, and it will be apparently understood from an example of the present disclosure. In addition, it will be easily understood that the objects and advantages of the present disclosure are realized by means and combinations described in the appended claims.

To achieve the above objective, the present disclosure provides a gas-liquid separator for a fuel cell vehicle including a casing part, in which gas introduced through a gas introduction opening flows while liquid is separated from the gas through a centrifugal force due to swirls thereof, a fluid guide part disposed inside the casing part, and in which the separated gas and liquid flow while being rotated along an inner circumferential surface thereof, wherein the liquid drops to be discharged and the gas is concentrated at a central portion thereof due to a density difference, a gas-liquid separating part disposed in the fluid guide part, and that separates the liquid contained in the gas due to the swirls while the gas passes therethrough, and a filter part that collects foreign substances from the liquid discharged after passing through the fluid guide part, blocks the gas, and collects foreign substances from the gas discharged after passing through the gas-liquid separating part.

In the gas-liquid separator for a fuel cell vehicle, an amount of the recovered energy of a turbine may be maximized by reducing a flow loss of the gas, the gas and the liquid discharged from the outlet of the fuel cell may be effectively separated to meet the separation efficiency, and a clogging phenomenon of the passage due to freezing in the winter season may be prevented.

In the gas-liquid separator according to the present disclosure, the casing part may include a first outer case part, in which a gas introduction opening is formed, and in which a vane part is formed to generate the swirls in the gas passing through the gas introduction opening, and a second outer case part coupled to a rear side of the first outer case part, in which a gas discharge opening extends in a direction facing the gas introduction opening, and in which a liquid discharge opening, through which the liquid separated from the gas is discharged, is formed at a lower portion thereof.

In the gas-liquid separator according to the present disclosure, the vane part may include a first vane part installed at an inlet of the gas introduction opening, and a second vane part installed at the inlet of the gas introduction opening on one side of the first vane part.

In the gas-liquid separator according to the present disclosure, the first vane part may be installed separately at the inlet of the gas introduction opening, and the second vane part may be installed integrally with the inlet of the gas introduction opening.

In the gas-liquid separator according to the present disclosure, the inlet of the gas introduction opening may be formed in a cylindrical shape having a first surface, on which the first vane part is installed, and a second surface, on which the second vane part is installed, on an inner side thereof, and the first vane part and the second vane part may include a wing portion, and a fixing portion that fixes an inner surface and an outer surface of the wing portion.

In the gas-liquid separator according to the present disclosure, the fixing portion of the second vane part may include an inner fixing portion that fixes the inner surface of the wing portion, and an outer fixing portion defined as an inner surface of the inlet of the gas introduction opening.

In the gas-liquid separator according to the present disclosure, the fluid guide part may include an outer circumferential surface portion having a smaller diameter than that of the second outer case part to be spaced apart from an inner circumferential surface portion of the second outer case part.

In the gas-liquid separator according to the present disclosure, the fluid guide part may include a front opening portion, a front surface of which is opened, and a rear opening portion, a rear surface of which is opened, and the rear opening portion may have a plurality of liquid discharge holes formed along an outer circumferential direction of a rear surface thereof, and at least one gas discharge hole formed at a central portion of the rear surface thereof.

In the gas-liquid separator according to the present disclosure, a front surface of the front opening portion may be fully opened, and a rear surface of the rear opening portion may be partially opened.

In the gas-liquid separator according to the present disclosure, the gas-liquid separating part may be disposed at a boundary of the liquid discharge hole and the gas discharge hole.

In the gas-liquid separator according to the present disclosure, the fluid guide part may include an eccentric circumferential surface portion having an arc shape of a large radius (R), of which a central axis of an inner circumferential surface is eccentric with respect to a central axis line of an outer circumferential surface thereof, and wherein the eccentric circumferential surface portion may include a stepped portion protruding from the inner circumferential surface toward a center thereof.

In the gas-liquid separator according to the present disclosure, a liquid exit hole communicated with the liquid discharge opening may be formed in the fluid guide part in a position being adjacent to the stepped portion.

In the gas-liquid separator according to the present disclosure, the gas-liquid separating part may be connected to a gas discharge hole shared by the second outer case part and a rear surface of the fluid guide part.

In the gas-liquid separator according to the present disclosure, the gas-liquid separating part may include a rear opening portion communicated with the gas discharge hole, and a front surface thereof may include a protruding cone portion protruding such that an outer diameter thereof becomes smaller toward a front side.

In the gas-liquid separator according to the present disclosure, the protruding cone portion may be formed to protrude in a conic shape such that the gas introduced through the gas introduction opening collides therewith to flow rearward along an inclined surface in a state, in which the liquid is separated therefrom.

In the gas-liquid separator according to the present disclosure, a gas passage part may be formed at a side portion and a lower surface portion of a circumferential surface of the gas-liquid separating part, and the gas passage part may include a gas passage hole, and a cover part that blocks the liquid to guide the liquid to the liquid discharge opening.

In the gas-liquid separator according to the present disclosure, the filter part may include a first filter part including a first filtration member, in which fine holes that collects foreign substances from the liquid is formed, and a second filter part including a second filtration member, in which fine holes that collects foreign substances from the gas.

In the gas-liquid separator according to the present disclosure, the first filter part may include a filter case, in which the first filtration member is interposed, and in which a through-hole, through which the liquid passes, is formed over an entire surface or a partial surface thereof, and a filter tray, on which the filter case including the first filtration member is seated.

In the gas-liquid separator according to the present disclosure, an accommodation part, in which the filter case is accommodated, may be formed in the filter tray, and a drainage portion, through which the liquid may be discharged in a gravitational direction, is formed at a lower portion of the accommodation part.

In the gas-liquid separator according to the present disclosure, the second filter part may include a filter frame surrounding the second filtration member, and the second filter part may be accommodated in an interior of the gas-liquid separating part.

In the gas-liquid separator according to the present disclosure, a plurality of ribs supporting the second filtration member in a lengthwise direction thereof may be formed in the filter frame.

In the gas-liquid separator according to the present disclosure, the fine holes of the second filtration member may be formed such that a porosity thereof is greater than a porosity of the fine holes of the first filtration member.

According to the gas-liquid separator for a fuel cell vehicle according to the present disclosure having the above-described configuration, an amount of recovered energy may be maximized by reducing a flow loss of the gas, and the gas and the liquid discharged from the outlet of the fuel cell may be effectively separated to satisfy a separation efficiency.

The present disclosure may be used in various environments by preventing a passage clogging phenomenon due to freezing in the winter season.

The above-mentioned description of the present disclosure is intended to be illustrative, and it should be understood by those skilled in the art that the present disclosure may be embodied in other specific forms without departing from the spirit or essential characteristics thereof. Therefore, the above-described examples are examples in all examples, and should be construed not to be restrictive. The scope of the present disclosure is defined by claims to be described below, and it should be interpreted that the scopes or claims of the present disclosure and all modifications or changed forms derived from the equivalent concept are included in the scopes of the present disclosure.

What is claimed is:

1. An apparatus for a fuel cell vehicle, the apparatus comprising:
a casing part comprising a gas introduction opening, wherein the gas introduction opening is configured to generate swirls in a gas-liquid mixture such that the gas-liquid mixture, as introduced into the casing part, is subjected to a centrifugal force that causes gas and liquid in the gas-liquid mixture to be separated, and wherein the casing part is configured such that the separated gas flows through the casing part;
a fluid guide disposed inside the casing part, wherein the fluid guide comprises an inner circumferential surface configured such that the separated gas and the separated liquid from the gas-liquid mixture are rotated along the inner circumferential surface, and wherein the fluid guide is configured such that the separated liquid is dropped and discharged and the separated gas is concentrated at a central portion of the fluid guide due to a density difference between the separated gas and the separated liquid;
a gas-liquid separator disposed in the fluid guide, wherein the gas-liquid separator is configured to separate remaining liquid contained in the separated gas; and
a filter part configured to:
collect foreign substances from the separated liquid, which is discharged after passing through the fluid guide,
block the separated gas, and
collect foreign substances from the separated gas, which is discharged after passing through the gas-liquid separator.

2. The apparatus of claim 1, wherein the casing part comprises:
a first outer case part, in which the gas introduction opening is formed and in which a vane part is provided to generate the swirls in the gas-liquid mixture; and
a second outer case part coupled to a rear side of the first outer case part, the second outer case part comprising:
a gas discharge opening that extends in a direction facing the gas introduction opening and configured to discharge the separated gas, and
a liquid discharge opening formed at a lower portion and configured to discharge the separated liquid.

3. The apparatus of claim 2, wherein the vane part comprises:
a first vane part installed at an inlet of the gas introduction opening; and
a second vane part installed at the inlet of the gas introduction opening, wherein the inlet of the gas introduction opening is on one side of the first vane part.

4. The apparatus of claim 3, wherein the first vane part is separately installed at the inlet of the gas introduction opening, and
wherein the second vane part is formed integrally with the inlet of the gas introduction opening.

5. The apparatus of claim 3, wherein the inlet of the gas introduction opening is formed in a cylindrical shape, wherein the cylindrical shape comprises:
a first surface, on which the first vane part is installed, and
a second surface, located on an inner side of the cylindrical shape, on which the second vane part is installed, and
wherein the first vane part and the second vane part, each comprises a wing portion and a fixing portion, and wherein the fixing portion is configured to fix an inner surface of the wing portion and an outer surface of the wing portion.

6. The apparatus of claim 5, wherein the fixing portion of the second vane part comprises:
an inner fixing portion configured to fix the inner surface of the wing portion; and
an outer fixing portion configured as an inner surface of the inlet of the gas introduction opening.

7. The apparatus of claim 2, wherein the fluid guide comprises an outer circumferential surface portion having a smaller diameter than an outer circumferential surface portion of the second outer case part, such that the fluid guide is spaced apart from an inner circumferential surface portion of the second outer case part.

8. The apparatus of claim 7, wherein the fluid guide comprises:
a front opening portion having an open front surface, and
a rear opening portion having an open rear surface, and
wherein the rear opening portion comprises:
a plurality of liquid discharge holes formed along an outer circumferential direction of a rear surface, and
at least one gas discharge hole formed at a central portion of the rear surface.

9. The apparatus of claim 8, wherein a front surface of the front opening portion is fully open,
wherein a rear surface of the rear opening portion is partially open, and
wherein the gas-liquid separator is disposed at a boundary between one of the plurality of liquid discharge holes and the at least one gas discharge hole.

10. The apparatus of claim 9, wherein the fluid guide comprises:
an eccentric circumferential surface portion having an arc shape of a radius, wherein a central axis of an inner circumferential surface of the eccentric circumferential surface portion is eccentric with respect to a central axis line of an outer circumferential surface of the eccentric circumferential surface portion,
wherein the eccentric circumferential surface portion comprises a stepped portion protruding from the inner circumferential surface toward a center of the fluid guide, and
wherein a liquid exit hole, in communication with the liquid discharge opening, is formed in the fluid guide at a position adjacent to the stepped portion.

11. The apparatus of claim 9, wherein the gas-liquid separator is connected to a gas discharge hole that is shared by the second outer case part and a rear surface of the fluid guide part, and
wherein the gas-liquid separator comprises:
a rear opening portion in communication with the gas discharge hole, and
a front surface having a protruding cone portion, wherein the protruding cone portion protrudes forward such that an outer diameter of the protruding cone portion decreases toward a front side.

12. The apparatus of claim 11, wherein the protruding cone portion is formed to protrude in a conic shape such that gas introduced through the gas introduction opening strikes the protruding cone portion and flows rearward along an inclined surface of the protruding cone portion, during which liquid is separated from the gas introduced through the gas introduction opening.

13. The apparatus of claim 11, wherein a gas passage part is formed at a side portion of a circumferential surface of the gas-liquid separator and a lower surface portion of the circumferential surface of the gas-liquid separator, and
wherein the gas passage part comprises:
a gas passage hole, and
a cover part configured to block the liquid from entering the gas passage hole and guide the liquid to the liquid discharge opening.

14. The apparatus of claim 1, wherein the filter part comprises:
a first filter part including a first filtration member having first holes, wherein the first holes are configured to collect foreign substances from the liquid; and
a second filter part including a second filtration member having second holes, wherein the second holes are configured to collect foreign substances from the separated gas.

15. The apparatus of claim 14, wherein the first filter part comprises:
a filter case that holds the first filtration member and comprises a through-hole for allowing liquid to pass through at least part of a surface of the filter case; and
a filter tray that supports the filter case and the first filtration member.

16. The apparatus of claim 15, wherein the filter tray comprises:
an accommodation part that houses the filter case, and
a drainage portion formed at a lower portion of the accommodation part and configured to discharge the liquid in a gravitational direction.

17. The apparatus of claim 14, wherein the second filter part comprises:
a filter frame that surrounds the second filtration member, and
wherein the second filter part is housed in an interior of the gas-liquid separator.

18. The apparatus of claim 17, wherein the filter frame comprises a plurality of ribs, and wherein the plurality of ribs extend in a lengthwise direction and support the second filtration member.

19. An apparatus comprising:
a case comprising a gas introduction opening and configured to generate a swirl in a gas-liquid mixture introduced through the gas introduction opening such that gas and liquid in the gas-liquid mixture are separated;
a gas discharge opening configured to discharge the separated gas;
a liquid discharge opening configured to discharge the separated liquid; and
a gas-liquid separator comprising:
a protrusion configured to deflect a flow of the separated gas rearward,
a gas passage hole formed on a surface of the gas-liquid separator, and
a cover part configured to guide the separated liquid to the liquid discharge opening.

20. An apparatus for a fuel cell vehicle, the apparatus comprising:
a first outer case comprising a gas introduction opening and a first vane and a second vane configured to generate a swirl in a gas-liquid mixture introduced through the gas introduction opening such that gas and liquid in the gas-liquid mixture are separated;
a second outer case coupled to the first outer case, the second outer case comprising a gas discharge opening configured to discharge the separated gas and a liquid discharge opening configured to discharge the separated liquid;
a fluid guide disposed within the second outer case, the fluid guide comprising:
a front opening portion,
a rear opening portion comprising a plurality of liquid discharge holes disposed along a circumferential edge and at least one gas discharge hole disposed at a central portion, and
an inner circumferential surface comprising an eccentric arc-shaped portion and a stepped portion adjacent to a liquid exit hole aligned with the liquid discharge opening;
a gas-liquid separator disposed at a central axis of the fluid guide and comprising:
a cone-shaped protrusion configured to deflect gas flow rearward,
a plurality of gas passage holes formed on side and lower surfaces of the gas-liquid separator, and
a cover part configured to guide separated liquid to the liquid discharge opening;
a first filter disposed at the liquid discharge opening and comprising a drainage portion; and
a second filter disposed within the gas-liquid separator and comprising a filtration member having greater porosity than the first filter.
